(19) United States
(12) Patent Application Publication
(10) Pub. No.: US 2013/0081524 A1
(43) Pub. Date: Apr. 4, 2013

(54) METHOD FOR MANUFACTURING LENS MOLDING CORE

(71) Applicants: YU-AN LIN, Tu-Cheng (TW); CHUN-KAI WANG, Tu-Cheng (TW)

(72) Inventors: YU-AN LIN, Tu-Cheng (TW); CHUN-KAI WANG, Tu-Cheng (TW)

(73) Assignee: HON HAI PRECISION INDUSTRY CO., LTD., Tu-Cheng (TW)

(21) Appl. No.: 13/335,970

(22) Filed: Dec. 23, 2011

(30) Foreign Application Priority Data
Sep. 29, 2011 (TW) 100135394

(51) Int. Cl. B23B 1/00

(52) U.S. Cl. 82/1.11

(57) ABSTRACT

A method for manufacturing a lens molding core includes the following steps. First, a blade is provided. Then, the blade is driven by a first driver to a number of cutting points in this order from the peripheral to the center of a molding surface of the lens molding core facing the blade at a fixed pitch, according to manufacturing parameters of the lens molding core. Wherein d is larger than or equal to the precision value of the first driver, and is less than or equal to about 3 micrometers, Finally, the lens molding core is driven by a second driver to move toward the blade along a central axis of the molding surface and spin about the central axis at each cutting point until the blade cuts into the molding surface a desired depth, according to the manufacturing parameters of the lens molding core.

### BACKGROUND

1. Technical Field

The present disclosure relates to molds and, particularly, to a method for manufacturing a high quality lens molding core.

2. Description of Related Art

Lens molding cores are manufactured by cutting. However, the roughness of the manufactured lens molding cores is high, and the manufactured lens molding cores have a number of circular micro-sized residues. The residues cooperatively form a diffractive grating have a spatial cycle equal to the pitch, which will be transferred to a lens molded by the lens molding core and produce a rainbow flare in images captured by the lens.

Therefore, it is desirable to provide a method for manufacturing a lens molding core, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a flowchart of a method for manufacturing a lens molding core, according to an embodiment.

FIG. 2 is a schematic, cross-sectional view of the lens molding core of FIG. 1.

FIG. 3 is a schematic view showing how to implement the method of FIG. 1.

### DETAILED DESCRIPTION

Embodiments of the present disclosure will now be described in detail with reference to the drawings.

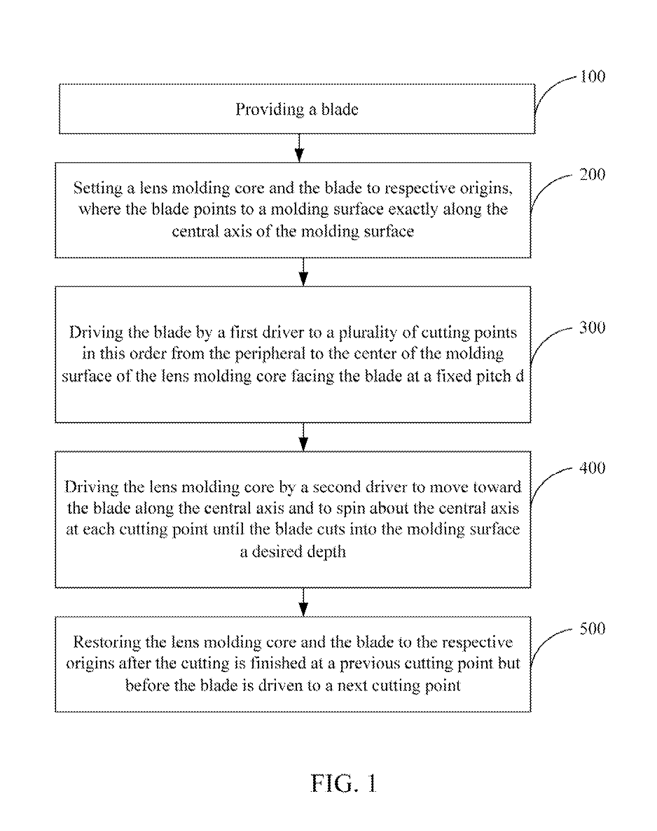

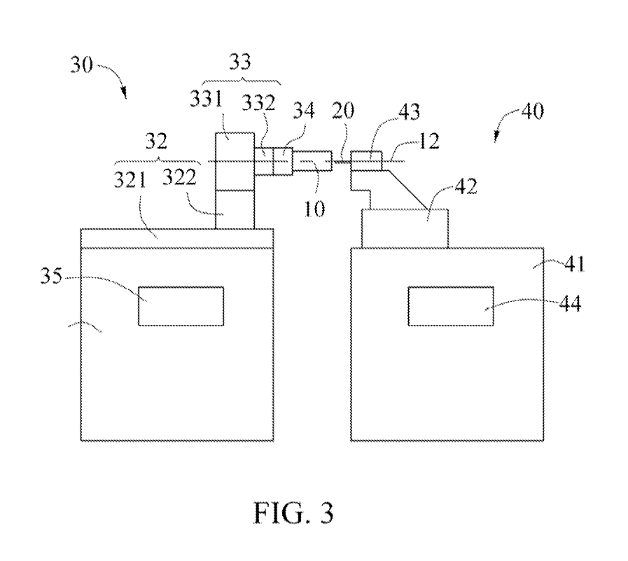

Referring to FIGS. 1-3, an embodiment of a method for manufacturing a lens molding core 10 includes the following steps 100-500.

In step 100, a blade 20 is provided.

The lens molding core 10 includes a molding surface 101 for molding a lens (not shown) and a central axis 12. The blade 20 points to the molding surface 101, and is used for cutting the molding surface 101.

The blade 20 is held by a first driver 40. The first driver 40 includes a first platform 41, a height adjuster 42, a first holder 43, and a first controller 44. The height adjuster 42 is positioned on the first platform 41. The first holder 43 is positioned on the height adjuster 42 and configured for holding the blade 20 in such a way that the blade 20 points to the molding surface 101 along a direction that is parallel to the central axis 12. The first controller 44 is configured for controlling the height adjuster 42 to adjust a height of the blade 20, according to the manufacturing parameters of the lens molding core 10. In this embodiment, the height adjuster 42 is a linear motor.

The lens molding core 10 is held and driven by a second driver 30. The second driver 30 includes a second platform 31 positioned adjacent to the first platform 41, a linear motor 32, a rotary motor 33, a second holder 34, and a second controller 35. The linear motor 32 includes a stator 321 positioned on the second platform 31 and a slider 322 movably riding on the stator 321. The linear motor 32 drives the slider 322 to slidably move on the stator 321. The rotary motor 33 includes a main body 331 connected to the slider 322 and a rotor 332 rotatably extending from the main body 331 along a direction that is substantially parallel to the sliding direction of the slider 322. The main body 331 drives the rotor 332 to spin about an axis (not shown), which is parallel to the extending direction, relative to the main body 331. The second holder 34 is connected to the rotor 332 and holds the lens molding core 10 in a manner that the central axis 12 passes through the axis about which the rotor 332 spins. The second controller 35 controls the linear motor 32 and the rotary motor 33, according to manufacturing parameters of the lens molding core 10.

In step 200, the lens molding core 10 and the blade 20 are set to respective origins, where the blade 20 points to the molding surface 101 exactly along the central axis 12.

In step 300, the blade 20 is adjusted to point to a cutting point on the molding surface 101 by the first driver 40. In this embodiment, the blade 20 is adjusted to a proper height by the height adjuster 42.

In step 400, the lens molding core 10 is driven to move toward the blade 20 along a direction that is substantially parallel to the central axis 12 and to spin about the central axis 12 until the blade 20 cuts into the molding surface 101 a desired depth, according to manufacturing parameters of the lens molding core 10. In this embodiment, the moving speed of the lens molding core 10 is 0.5 millimeter per minute (mm/min), the desired depth is 1 micrometer (μm), the rotating speed of the rotary motor 33 is 1200 revolutions per minute (r.p.m).

In step 500, the lens molding core 10 is moved back to its origin and the blade 20 moves out of the lens molding core 10.

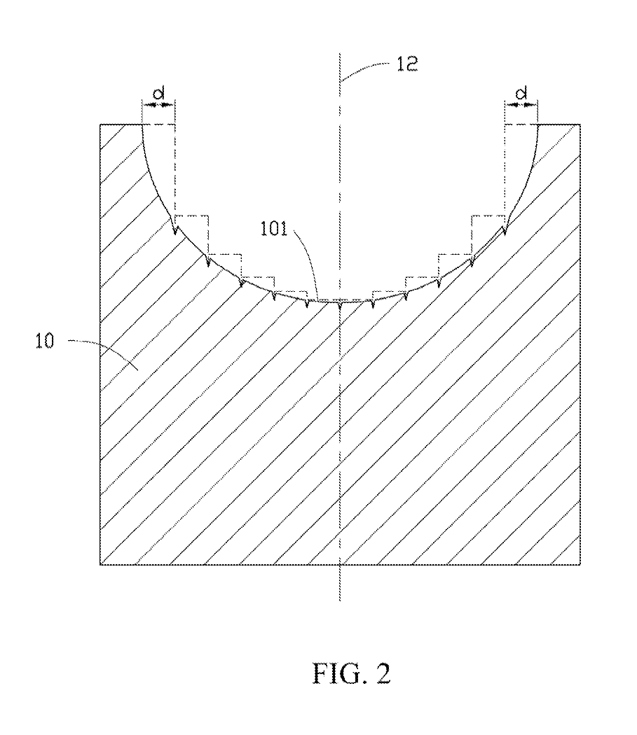

FIG. 2 shows the dotted line showing the moving trace of the blade 20. Steps 300, 400 and 500 are repeated until a number of circular and concentric micro-scaled residues are formed on the molding surface 101 and each residue is positioned between two adjacent cutting points. The blade 20 is adjusted to point to the cutting points in this order from the peripheral portion to the center of the molding surface 101 by the first driver 40 at a fixed pitch d, according to the manufacturing parameters of the lens molding core 10, that is, the blade 20 is adjusted to a number of different heights at the fixed pitch d. As a result, the residues cooperatively form a diffractive grating having a spatial cycle equal to the fixed pitch.

In other words, the blade 20 is driven to a number of cutting points in this order from the peripheral to the center of the molding surface 101 by the first driver 40 at a fixed pitch less than about 500 nm, according to the manufacturing parameters of the lens molding core 10, in step 300, and, the lens molding core 10 is driven to move toward the blade 20 along a direction that is substantially parallel to the central axis and to spin about the central axis at each cutting point until the blade 20 cuts into the molding surface 101 a desired depth, according to the manufacturing parameters of the lens molding core 10, in step 400.

The fixed pitch d is larger than or equal to the precision value of the first driver 40, and is less than or equal to about 3 μm. In this embodiment, the precision value of the second driver 40 is 0.05 μm.

It is proved by numerous experiments that the d is smaller, the roughness of the molding surface 101 is smaller, that is, the d is smaller, the molding surface 101 is smoother.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A method for manufacturing a lens molding core, comprising:
providing a blade;
driving the blade by a first driver to a plurality of cutting points in this order from the peripheral to the center of a molding surface of the lens molding core facing the blade at a fixed pitch d, according to manufacturing parameters of the lens molding core, wherein d is larger than or equal to the precision value of the first driver, and is less than or equal to about 3 micrometers; and
driving the lens molding core by a second driver to move toward the blade along a central axis of the molding surface and to spin about the central axis at each cutting point until the blade cuts into the molding surface a desired depth, according to the manufacturing parameters of the lens molding core.

2. The method of claim 1, further comprising:
setting the lens molding core and the blade to respective origins, where the blade points to the molding surface exactly along the central axis; and
restoring the lens molding core and the blade to the respective origins after the cutting is finished at a previous cutting point but before the blade is driven to a next cutting point.

3. The method of claim 1, wherein the first driver comprises a first platform, a height adjuster, a first holder, and a first controller, the height adjuster is positioned on the first platform, the first holder is positioned on the height adjuster and configured for holding the blade in such a way that the blade points to the molding surface along a direction that is parallel to the central axis, the first controller is configured for controlling the height adjuster to adjust a height of the blade, according to the manufacturing parameters of the lens molding core.

4. The method of claim 3, wherein the second driver comprises a second platform, a linear motor, a rotary motor, a second holder, and a second controller, the linear motor comprises a stator positioned on the second platform and a slider movably riding on the stator, the linear motor is configured for driving the slider to slidably move on the stator, the rotary motor comprises a main body connected to the slider and a rotor rotatably extending from the main body along a direction that is substantially parallel to the sliding direction of the slider on the stator, the main body is configured for driving the rotor to spin in relative to the main body, the second holder is connected to the rotor and configured for holding the lens molding core in a manner that the central axis is coaxial with the axis about which the rotor spins, the second controller is configured for controlling the linear motor and the rotary motor, according to the manufacturing parameters of the lens molding core.

5. The method of claim 4, wherein the manufacturing parameters of the lens molding core comprise a rotating speed of the rotary motor which is about 1200 rounds per minute.

6. The method of claim 1, wherein the manufacturing parameters of the lens molding core comprise a moving speed the lens molding core which is about 0.5 millimeters per minute.

7. The method of claim 1, wherein the manufacturing parameters of the lens molding core comprise the desired depth which is about 1 micrometer.

8. The method of claim 1, wherein the fixed pitch d is about 1 micrometer.

9. A method for manufacturing a lens molding core, the lens molding core having a molding surface, the method comprising:
(a) providing a blade;
(b) driving the blade by a first driver to point to a cutting point on the molding surface;
(c) driving the lens molding core by a second driver to move toward the blade along a central axis of the molding surface and to spin about the central axis until the blade cuts into the molding surface a desired depth;
(d) moving the lens molding core by the second driver back in such a way that the blade moves out of the lens molding core; and
(e) repeating the steps (b), (c) and (d) until a plurality of circular and concentric micro-scaled residues are formed on the molding surface and each residue is positioned between two adjacent cutting points, wherein the blade is driven to point to the cutting points in this order from a peripheral portion to the center of the molding surface at a fixed pitch d, wherein d is larger than or equal to the precision value of the first driver, and is less than or equal to about 3 micrometers, such that the residues cooperatively constitute a diffractive grating having a spatial cycle equal to the fixed pitch.

10. The method of claim 9, wherein in the step (a) the blade points to the molding surface exactly along the central axis.

11. The method of claim 9, wherein the first driver comprises a first platform, a height adjuster, a first holder, and a first controller, the height adjuster is positioned on the first platform, the first holder is positioned on the height adjuster and configured for holding the blade in such a way that the blade points to the molding surface along a direction that is parallel to the central axis, the first controller is configured for controlling the height adjuster to adjust a height of the blade.

12. The method of claim 11, wherein the second driver comprises a second platform, a linear motor, a rotary motor, a second holder, and a second controller, the linear motor comprises a stator positioned on the second platform and a slider movably riding on the stator, the linear motor is configured for driving the slider to slidably move on the stator, the rotary motor comprises a main body connected to the slider and a rotor rotatably extending from the main body along a direction that is substantially parallel to the sliding direction of the slider on the stator, the main body is configured for driving the rotor to spin in relative to the main body, the second holder is connected to the rotor and configured for holding the lens molding core in a manner that the central axis is coaxial with the axis about which the rotor spins, the second controller is configured for controlling the linear motor and the rotary motor.

13. The method of claim 12, wherein a rotating speed of the rotary motor is 1200 rounds per minute.

14. The method of claim 9, wherein a moving speed the lens molding core is about 0.5 millimeters per minute.

15. The method of claim 9, wherein the desired depth is about 1 micrometer.

16. The method of claim 9, wherein the fixed pitch d is about 1 micrometer.
